(19) United States
(12) Patent Application Publication
(10) Pub. No.: US 2009/0323318 A1
(43) Pub. Date: Dec. 31, 2009

(54) Illuminated plant stand

(76) Inventor: Man-Yan Chan, Kowloon (HK)

Correspondence Address: ALIX YALE & RISTAS LLP, 750 MAIN STREET, SUITE 1400, HARTFORD, CT, 06103, US

(21) Appl. No.: 12/215,245

(22) Filed: Jun. 25, 2008

(51) Int. Cl. F21S 19/00; F21S 6/00; F21V 33/00

(52) U.S. Cl. 362/122; 362/234

(57) ABSTRACT

A plant stand includes a base for supporting a contained plant, a hood positioned above the base and a light source mounted to the hood for emitting light toward the base. An adjustable support member is mounted to the base and supports the hood in such a way that the distance between the light source and the base can be adjusted as the plants grow.

### BACKGROUND OF THE INVENTION

The present invention relates to plant stands. More particularly, although not exclusively, the invention relates to a plant stand for displaying indoor pot plants.

Indoor plant housings and plant stands upon or within which plants can be placed for indoor display are of course known. These include transparent terrariums for example and open stands upon which potted plants can be displayed.

The known display stands do not provide light necessary for plant photosynthesis and therefore must be placed alongside a window or other place where natural light impinges in order to promote plant growth or at least sustain the health of a plant. Furthermore those providing a finite internal space such as terrariums are not well suited to accommodating a growing plant.

### OBJECTS OF THE INVENTION

It is an object of the present invention to overcome or substantially ameliorate at least one of the above disadvantages and/or more generally to provide an improved plant stand.

### DISCLOSURE OF THE INVENTION

There is disclosed herein a plant stand, comprising:

a base for supporting a contained plant;

a hood positioned a distance above the base;

a first light source mounted to the hood for emitting light toward the base; and

an adjustable support member mounted to the base and supporting the hood in such manner that said distance can be adjusted.

Preferably, the plant stand then further comprises a second light source of different type to the first light source and also mounted to the hood for emitting light toward the base.

Preferably, the first light source comprises a compact fluorescent lamp.

Preferably, the first light source comprises a plurality of LEDs.

Preferably, the second light source comprises a plurality of LEDs.

Preferably, the adjustable support member comprises an upper pole telescopically received by a lower pole.

Preferably, there is a plurality of said support members.

Preferably, at least one of the support members includes a resiliently mounted locking button passing selectively through one of a plurality of apertures of the upper pole and one of a plurality of apertures of the lower pole.

Preferably, the base includes a perforated plate upon which a pot plant can rest and through which water can drain.

### BRIEF DESCRIPTION OF THE DRAWINGS

A preferred form of the present invention will now be described by way of example with reference to the accompanying drawings, wherein:

FIG. 1 is a schematic elevation of a plant stand;

FIG. 2 is another schematic elevation of the plant stand;

FIG. 3 is a schematic inverted plan view the underside of the hood of the plant stand of FIGS. 1 and 2: and

FIG. 4 is a schematic plan view of the base of the plant stand.

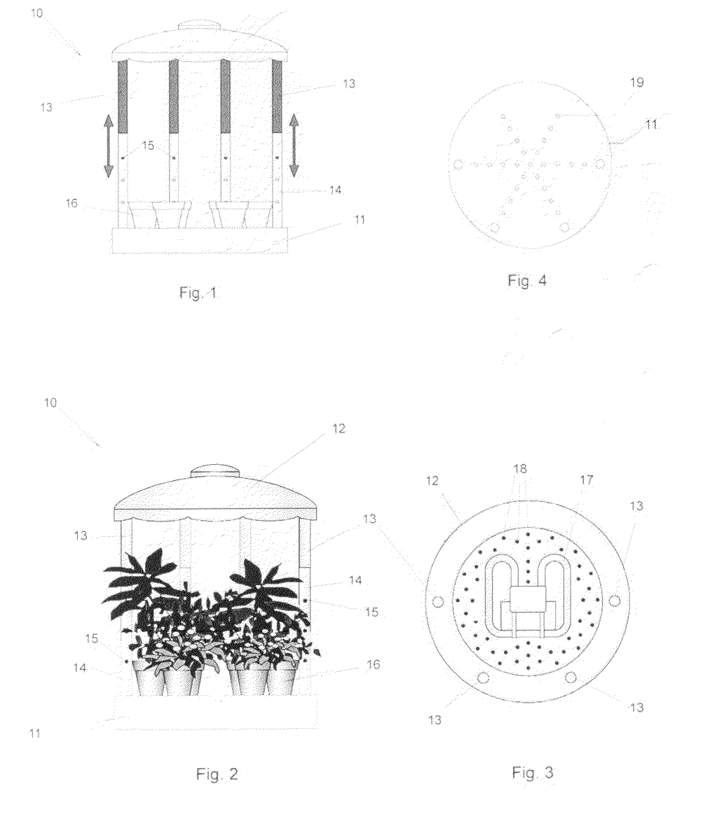

### DESCRIPTION OF THE PREFERRED EMBODIMENT

In the accompanying drawings there is depicted schematically a plant stand 10 comprising a base 11 and a hood 12 which is supported in spaced relationship above the base 11 by a number of telescopic poles each comprising upper pole parts 13 and lower pole parts 14. Each pole part 13, 14 comprises an array of apertures through which resiliently mounted locking buttons 15 (typically of the type used in telescopic pool cleaning poles or the extendable legs of hospital stools for example) extend.

The base 11 is sized to receive a number of plant pots 16.

The base 11 includes a perforated pot plant-support plate 19 through which excess water from the pot plants can drain to a drip tray (not shown) which is positioned beneath the plate.

Mounted to the underside of the hood 12 is a compact fluorescent lamp 17 and a plurality of downward facing LEDs 18. These can receive electric power from batteries mounted either in the base 11 or hood 12, or via an electric cable to a mains power outlet. The compact fluorescent lamp 17 can be switched on and off independently of the LEDs 18. Similarly, the LEDs 18 can be switched on and off independently of the compact fluorescent lamp 17. That is, in each case, two separate switches can be provided. As an alternative, the compact fluorescent lamp 17 and LEDs 18 can be switched on and off together by a single switch. The underside of the hood 12 would typically be reflective to reflect light emitted by the compact fluorescent lamp 17 downward.

The compact fluorescent lamp 17 is intended to emit relatively high intensity light over the growing plants in pots 16, whereas the LEDs 18 are intended to provide less intense “effects” or mood lighting. Of course depending on the selection of components, high intensity LEDs for example might be used to provide a relatively higher light intensity over the growing plants than regular LEDs.

Both the compact fluorescent lamp and LEDs might be selected to emit light of a selected wavelength range appropriate for assisting plant growth.

As the plants grow, the hood 12 can be raised by depressing the locking buttons 15 and raising the hood 12 as the poles extended telescopically to a desired length at which the resiliently mounted locking buttons 15 extend through aligned apertures to again lock the poles in position. To enable this to be performed by a single person, it might be appropriate to provide locking buttons and associated apertures in only two of the poles 13, 14 thereby leaving the remaining poles freely extendable and contractible.

It should be appreciated that modifications and alterations obvious to those skilled in the art are not to be considered as beyond the scope of the present invention. For example, additional LEDs might be placed in an upward facing configuration in the base 11 to provide under-leaf illumination.

1. A plant stand, comprising:
a base for supporting a contained plant;
a hood positioned a distance above the base;
a first light source mounted to the hood for emitting light toward the base; and
an adjustable support member mounted to the base and supporting the hood in such manner that said distance can be adjusted.

2. The plant stand of claim 1, further comprising a second light source of different type to the first light source and also mounted to the hood for emitting light toward the base.

3. The plant stand of claim 1, wherein the first light source comprises a compact fluorescent lamp.

4. The plant stand of claim 1, wherein the first light source comprises a plurality of LEDs.

5. The plant stand of claim 3, wherein the second light source comprises a plurality of LEDs.

6. The plant stand of claim 1, wherein the adjustable support member comprises an upper pole telescopically received by a lower pole.

7. The plant stand of claim 6, comprising a plurality of said support members.

8. The plant stand of claim 7, wherein at least one of the support members includes a resiliently mounted locking button passing selectively through one of a plurality of apertures of the upper pole and one of a plurality of apertures of the lower pole.

9. The plant stand of claim 1, wherein the base includes a perforated plate upon which a pot plant can rest and through which water can drain.
